(19) United States
(12) Patent Application Publication
(10) Pub. No.: US 2004/0181790 A1
(43) Pub. Date: Sep. 16, 2004

(54) System and method for maintaining installed software compliance with build standards

(76) Inventor: Joseph W. Herrick, Woodbridge, VA (US)

Correspondence Address: REED SMITH LLP, 2500 ONE LIBERTY PLACE, 1650 MARKET STREET, PHILADELPHIA, PA, 19103, US

(21) Appl. No.: 10/799,950

(22) Filed: Mar. 12, 2004

Related U.S. Application Data
(60) Provisional application No. 60/473,636, filed on May 27, 2003.
(60) Provisional application No. 60/454,022, filed on Mar. 12, 2003.

(51) Int. Cl. G06F 9/44; G06F 9/445

(52) U.S. Cl. 717/168; 717/174

(57) ABSTRACT

The present invention is a process for automated determining whether software packages installed on a target computer are current, and when the software packages are determined not to be current, for obtaining and installing updates, upgrades, and patches as necessary to bring the installed software to a current configuration.

### FIELD OF THE INVENTION

The present invention pertains to the management of grouped computer servers, and more particularly to the task of ensuring that software installations comply with desired versions, service pack installations, and/or are current as desired.

### BACKGROUND OF THE INVENTION

The increased use of the Internet as a means for disseminating information and applications for businesses has resulted in the increasing use of server farms, where servers are collocated to provide efficiencies in the operation and maintenance of the servers. Such servers typically require several programs or groups of programs (hereafter referred to collectively as “software packages”) to be operating on the server, to handle a wide variety of functions. These programs may be provided by one or more vendors. Each software package may include several related programs for handling different functions. Accordingly, a server used to host an Internet application may have a large number of installed software packages.

Each software package may need to be upgraded or updated from time to time. For example, a software vendor may issue service packs to correct security deficiencies in a software package. Other software packages may be upgraded as new versions come along with additional features. The updates to the software may typically be called, but are not limited to, patches, service packs, releases, versions, upgrades, and updates (hereafter referred to collectively as “updates.”) In a case where a program has not been updated recently, intermediate upgrades or updates may need to be implemented in order for most recent upgrades or updates to perform correctly. Additionally, some upgrades or updates may require the presence of other programs, such that dependencies may control the successful installation of an upgrade or update. Accordingly, the current configuration of an installed program, as well as the configuration of the computer or server on which the program is installed, may be critical to the successful installation of upgrades or updates.

Although configuration lists generated when software is initially installed on a server or computer (hereafter referred to as the “original build”) may be maintained, inaccuracies in such a configuration list may have severe consequences. For example, if a software update is listed as having been installed, a failure of the initial installation could cause the absence of a critical update required to ensure security for the server on which the software is installed. Errors in configuration lists may arise when software installations are unsuccessful (but marked as successful), when an installer forgets to install a software program, update, or upgrade, or when intermediate updates or upgrades are or are not installed, with inconsistent changes made to the configuration list.

Determination of a desired server program version list may be an administrative or engineering function, such that a record may be made of what software should be installed on a particular server, based on the recommendations of vendors associated with the installed software, based on known software compatibilities, or based on any other known considerations. Having such a list, however, neither addresses required intermediate installations, or installation of required software itself Accordingly, large scale manual intervention, with associated adverse effects, may be required in order to ensure build compliance

Manually installing software packages may be time consuming, as an operator may be required to wait while software loads, awaiting requests for information from the software while it installs, or loading and unloading storage media on which application software is stored.

### SUMMARY OF THE INVENTION

The present invention is a process for automatedly determining whether software packages installed on a target computer are current, and when the software packages are determined not to be current, for obtaining and installing updates, upgrades, and patches as necessary to bring the installed software to a current configuration.

In one embodiment, the present invention is a method for testing a computer to determine whether software packages installed on the computer are up to date. The process may begin with the running of an executable program on the target network computer to determine whether the configuration of at least one installed software package on the networked computer is current. Once the configuration of the software package has been determined, the information obtained may be compared against a list identifying a desired configuration for the software package. From the comparison, it may be determined whether the installed software package is current, and if it is determined that the software package is not current, what software updates, upgrades, or patches should be applied to bring the software package up to a current level.

The present invention may also be involved in a computer system including the target computer, a network, and administrative computer containing information defining a desired configuration for the target computer, and one or more library servers containing software updates, upgrades, or patches for installation onto the target computer. The target computer may have an executable program thereon for automatically determining the currency of software installed on the target computer, comparing the currency of the installed software to a desired configuration list stored on the administrative computer, and obtaining installation software from a library server including necessary updates, upgrades and patches for installation on the target computer.

### BRIEF DESCRIPTION OF THE FIGURES

FIG. 1 illustrates a simplified process for automatically ensuring program version compliance with a pre-determined program configuration.

FIG. 2 illustrates a notational list of installed software.

FIG. 3 illustrates a notional desired configuration list.

FIG. 4 illustrates a notional record associated with identifying intermediate installations for a given software product, as dependant on revision levels.

FIG. 5 illustrates a notional computer network incorporating an embodiment of the present invention.

FIG. 6 shows a specific embodiment of the present process.

FIG. 7 illustrates a process for setting parameters received in a command line instruction as implemented in conjunction with the process of FIG. 6.

FIG. 8 illustrates in more detail a process for checking a target computer to determine whether necessary software programs for running an update program are installed as implemented in conjunction with the process of FIG. 6.

FIG. 9 illustrates in more detail a process for loading desired version information as implemented in conjunction with the process of FIG. 6.

FIG. 10 illustrates in more detail the step of detecting installed software packages as implemented in conjunction with the process of FIG. 6.

FIG. 11 illustrates in more detail a process for identifying updates for installed software as implemented in conjunction with the process of FIG. 6.

FIG. 12 illustrates in more detail a process for determining whether an update has been superceded as implemented in conjunction with the process of FIG. 6.

FIG. 13 illustrates in more detail a process for loading update installation programs on a target computer as implemented in conjunction with the process of FIG. 6.

FIG. 14 illustrates in more detail a process for verifying updates as implemented in conjunction with the process of FIG. 6.

FIG. 15 illustrates in more detail a process for installing updates as implemented in conjunction with the process of FIG. 6.

### DETAILED DESCRIPTION OF THE INVENTION

The present invention is designed as an automated version verification and revision or upgrade installation tool to ensure server compliance with a desired configuration. As is known to those possessing an ordinary skill in the pertinent arts, software packages may be designed on a quarterly release schedule, such as Microsoft Windows, for example. Further, once a software package is released various supplemental packages such as new versions, upgrades, software fixes and/or patches may be released more frequently. These releases, supplemental packages, new versions, upgrades, revisions, fixes, patches and service packs are hereafter collectively referred to as “versions”. In order to maintain proper functionality, specific levels of a software build, typically but not always the most recent, may be required to minimize security risks and maximize interoperability.

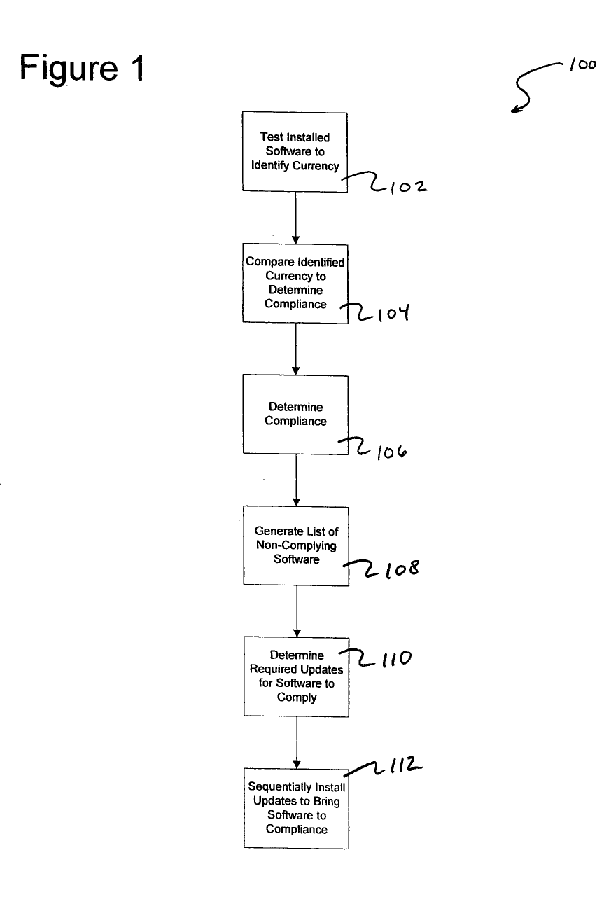

Referring now to FIG. 1, there is shown a basic process 100 for automatically ensuring program version compliance with a desired configuration. The first step is to identify 102 versions or configurations (hereafter referred to as “currency”) of installed software on a computer for which it is desired to verify the currency of the installed software. Once versions or configurations have been identified 102, the identified versions may be compared 104 to an identified build level to determine compliance 106. A list of non-complying software may then be generated 108. For non-complying software, an installation sequence may be determined 110, allowing updates to be installed 112 to bring software to compliance.

The process of identifying the currency of installed software on a computer may preferably be accomplished by executing a computer program on the target computer to determine the currency of installed software packages. Implementing the capability to test specific programs allows the size of the test program to be controlled, such that the amount of time necessary to execute the program, and identify the currency of installed software, may be kept manageable. It is possible to generate test capabilities to determine the currency of any program which could be installed on a computer, however such a capability would require protracted time to execute, as well as a very large database containing parameters to be used in such identifications.

Typically, no single list on a computer identifies each software package installed. Accordingly, alternate methods of determining installed versions or configurations may need to be implemented. For a target computer using the Microsoft WINDOWS operating system, three methods which accomplish such testing include analysis of registry data, analysis of installed files, and program data, such as is accessible through the help: about information.

The registry is a database that Microsoft WINDOWS operating system uses to store operational parameters, including installed software packages. The registry is a file resident on the computer, and may be examined to determine parameters stored in the target computer. Some programs have registry entries which allow identification of the currency of the program. Accordingly, the currency of an installed software package may be able to be identified from the registry entry.

Alternately, where specific file parameters are known, the specific file parameter may be tested to determine the currency of an installed software package. For example, the build date of a file within the software package may serve as an indicator of the currency of the installed software package. Care must be used to avoid testing an archived copy of the software, rather than the operating version of the installed software package.

Finally, many Windows programs provide information which is accessible to a user of the computer in the help:about box. The help:about box is accessible through the help pull down on the graphical user interface, such that selection of the about [program name] line results in a description of the installed software package, including currency information. The displayed currency information may be used to determine the currency of the installed program.

In a simple form, the program used to identify the currency of installed software packages may be resident on the target computer, such that the program may be executed by an operator at the target computer. Alternately, the program installed on the target computer may be executed remotely, such as through a remote insight board, or through a remote control software application. The program may alternately be transferred to the target computer over the network, or executed from a remote location.

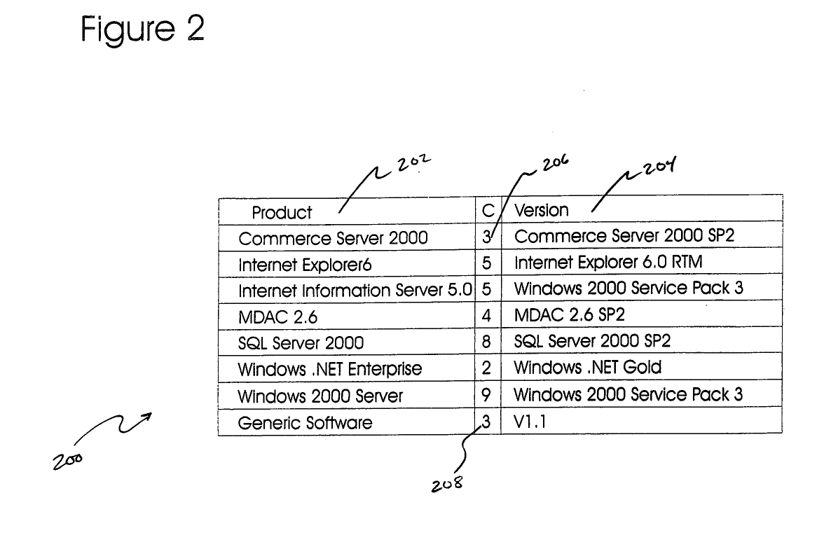

When executed, the program may generate a list of the currency of specific software packages, if installed, such as shown in FIG. 2. The list may identify software packages identified, and the version presently installed. A sequential number may be associated with each successive version to simplify comparisons.

Alternately, the program may obviate the step of generating a list of installed software packages by sequentially testing each installed software package against a desired build list, and then identifying non-compliant software packages.

The currency list 200 may be formatted as desired to be compatible with software operating on separate computer able to parse the information contained in the currency list 200. Preferably, a tagged field format, such as HTML or XML may be implemented, such that the administrative computer may more easily determine the context of a reported present version list. For example, where a tagged field format is implemented, the administrative computer receiving a present version list will be able to understand the relevance of reported data based on the field identifier, rather than having to resort to a parse and compare routine to establish the significance of a value.

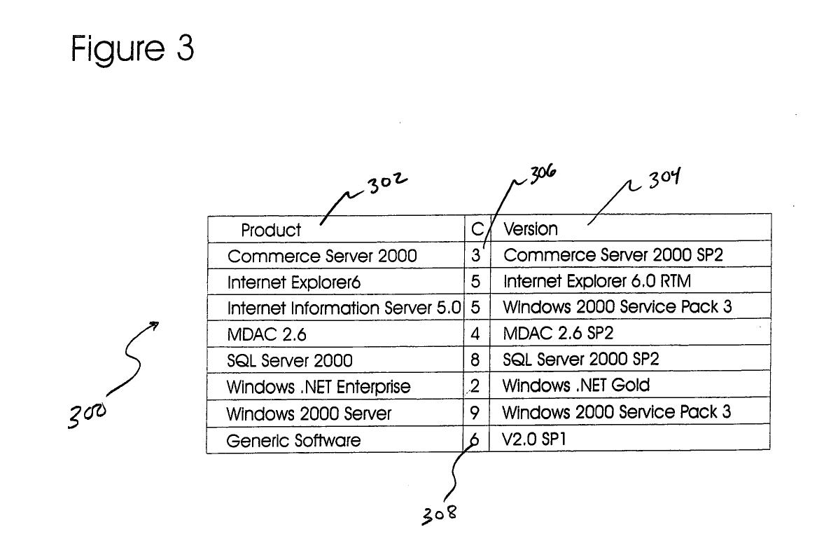

A desired build list is shown in FIG. 3. The desired build list 300 is similar to the software currency list 200 shown in FIG. 2, but contains information defining the desired version 304 for a given software package 302, as opposed to the installed version. Again, a sequential identifier 306 may be associated with the desired version to simplify comparisons.

The desired build list may identify the most current software versions, or may list specific software versions desired for the target computer, such as to enable specific software to be run on the target computer. Where a software library of upgrades has been created, the desired build list may be determined by testing the software present in the library of upgrades to determine the most current version. The use of the library of upgrades as the basis for the desired build list may be problematic, in that software in the library may not be considered ready for deployment, i.e., be a beta version of the software released in a limited fashion for testing.

Alternately, such as where legacy software is desired, the desired build list 300 may be manually created by a person or entity responsible for managing the target computer, to allow the user or entity to specify specific versions (not necessarily the most current) versions of a software package.

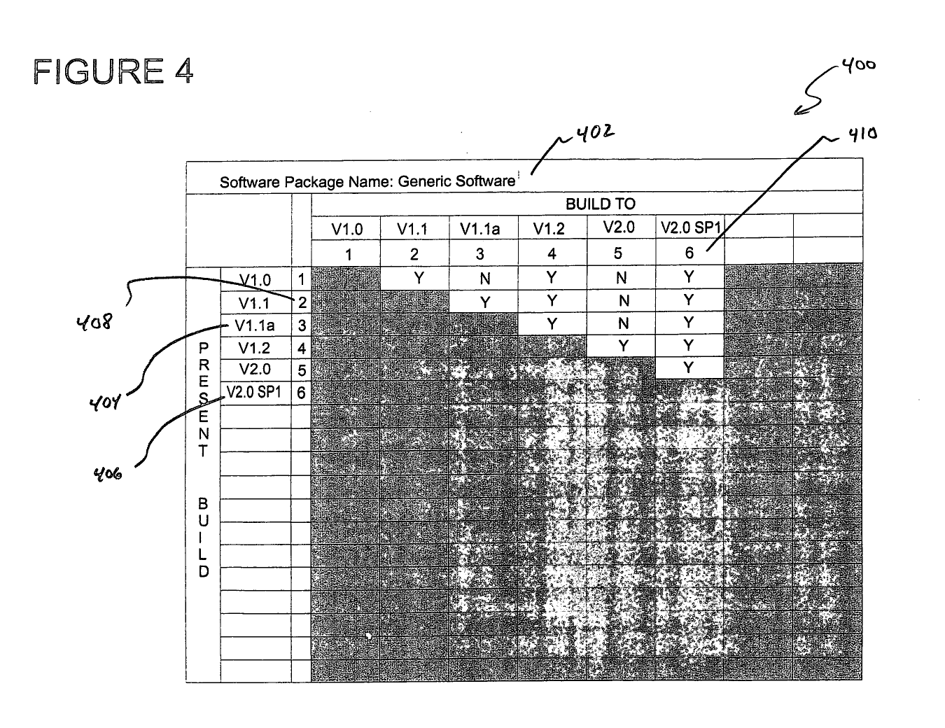

Once the desired build list 300 and currency list 200 have been determined, the currency list 200 may be compared to the desired build list 300 to identify software packages for which upgrades or updates are required to bring the installed software packages to the desired level. Such an update or upgrade process may not be as simple as just installing the most recent version or installation, but may require the installation of intermediate upgrades or updates. FIG. 4 shows a table for identifying necessary intermediate updates or upgrades for a hypothetical Generic Software Package 402, including updates 404 and service packs 406. For a given currency level, the necessary intermediate installations may be determined by stepping from the current version to the desired version, checking at each step to determine whether the intermediate version is required to be installed for later versions. As the necessity of intermediate versions may be obviated by later intermediate releases, a list of intermediate installations may be dependant upon the current version as well as the desired version, in order to avoid the installation of unnecessary intermediate installations.

For example, using a sequential number to identify versions of a software package, the installed sequential version identifier (shown as 208 on FIG. 2) may be compared with a desired sequential version identifier (shown as 308 on FIG. 3) to determine that Generic Software needs to be updated from sequential version 2 to sequential version 6. This information may be referenced against a software package version record, such as that shown in FIG. 4 for the notional Generic Software, to arrive at the conclusion that Version 1.1a (sequential number 3), V1.2 (sequential number 4), and V2.0 SP1 (sequential number 6) need to be installed to bring the installed version of Generic Software to the desired version level, and that V2.0 (sequential number 5) does not need to be installed as an intermediate level.

The comparison of the currency list 200 to the desired build list 300 may result in the generation of a list of software installations to be executed. This list may be presented to an operator for manual installation of the software upgrades and updates, or may be installed through an automated installation routine, such as described in published United States Patent Application No. 2002112232. The installation of the updates and upgrades may be monitored to develop a list of installed packages (indirectly resulting in a list of installations after execution of the updating program), such that the currency level of the target computer after the upgrade and update cycle may be maintained.

The update list may then be passed to a program for generating an update script. The update script is intended to be installed on the target computer, and to cause the target computer to download and install updates to installed software packages to bring the software packages installed on the target computer to the desired version levels for software.

The update script may be generated by aggregating script modules associated with each required update. Each script section may be pre-developed for the particular version of each software package, such that modules may be appended within the script file to generate a complete script file for updating the target computer.

The completed script file may then be transferred to the target computer for execution. The script file may execute for each desired update installation, and provide necessary responses to intervention requests generated by an update installation program. For example, should a software update require license information, the script may have been previously provided with the license information, or be able to reference the license information. Once any intervention information has been requested during installation of an update, the script may instruct the target computer to provide the appropriate response to the intervention request.

During execution of the script, the target computer may generate an installation report noting the success or failure of each installation. The installation report may be forwarded to an administrator to allow the administrator to determine whether further action needs to be taken, based on the success or failure of each installation. Alternately, the installation report may be stored for later use in determining whether additional updates are required for the target computer.

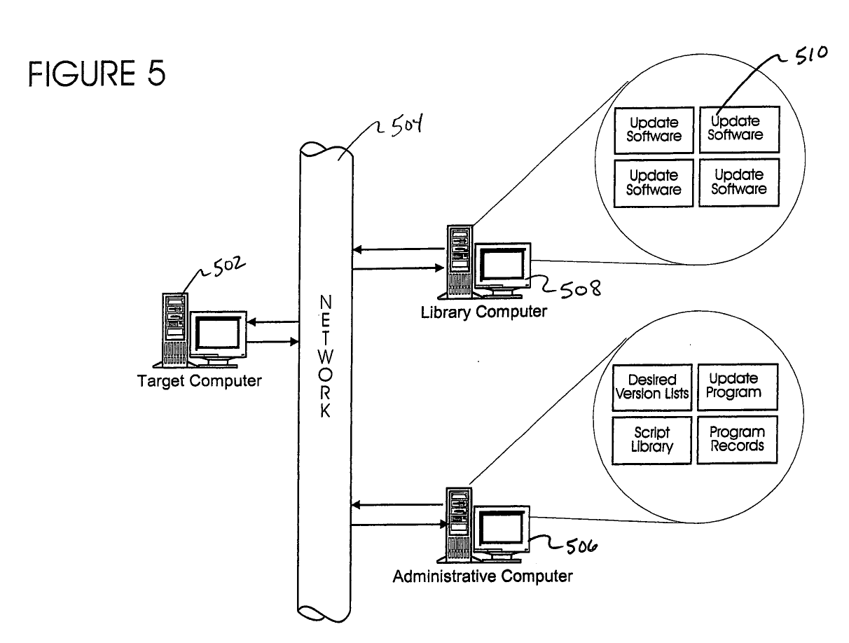

FIG. 5 shows a notional computer network in which the present invention may be embodied. A computer 502 for which upgrades are desired may be connected to a network 504. The network 504 may be an internal network, or an open network, such as the Internet. The computer 502 for which upgrades are desired (hereafter referred to as “the target computer 502”) may be a server, a workstation, or any other form of computer. An administrative server 506 may also be connected to the network 504 that the target computer 502 is connected to, such that the administrative computer 506 may transfer files to the target computer 502. The administrative computer 506 may be the source for an upgrade program to be executed on the target computer 502, or the source where control information is stored, such as desired build lists. Such file transfer may be implemented through remote control hardware or software, such that the administrative computer 506 may cause actions to be taken on the target computer 502.

Update software for installation may be stored on one or more library servers 508, or the function may be incorporated into the administrative computer 506. The library servers 508 may contain installation software 510 for a vendors program, including legacy versions which may be required in the updating of software on the target computer.

The administrative computer 506 may receive a currency list 200 transmitted from the target computer 502, and compare the currency list 200 against a desired configuration list (such as that shown in FIG. 4) stored on the administrative computer 506 for software on the target computer 502. The desired version list 300 may either be based on the software installed on the target computer, or based on a desired list generated externally, such as by a system administrator.

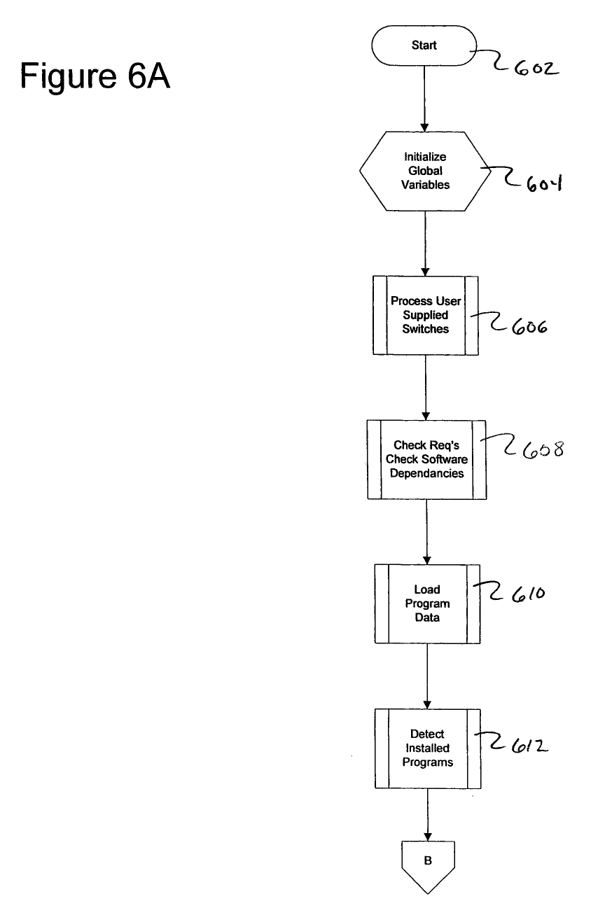

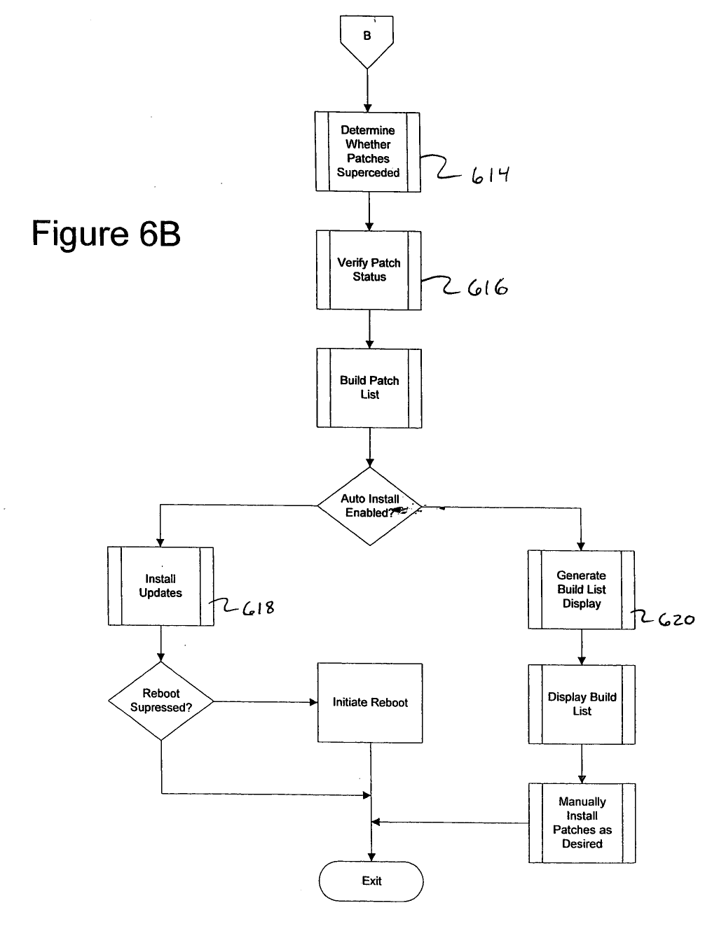

The process associated with a particular embodiment of the present invention is shown in FIG. 6, as implemented in a computer network on which the target computer includes an update program for executing an automatic update. The first step may include starting the update program on the target computer 602. Starting the update program may involve providing the command line to run the program at the command prompt. The command line may include information regarding how the process is to function, such as control variables required for the proper function of the update program. The command line may be entered at the command prompt of the target computer either actually at the target computer, or remotely, such as through the use of a remote interface board which allows control of the target computer from a remote location connected to the target computer via a network.

Once the process has started 602, initial global variables may be set 604 on the target computer. The initial global variables may include creating and initializing data structures. Once the initial global variables have been set, any command line switches supplied by a user may be processed 606. Command line variables may be switches providing instructions to include or not include certain actions. For example, a switch may be set transferring responsibility for requested interventions from an automatic mode to a manual mode. Alternately, a switch may be set to allow non-released (“beta”) updates to be included or excluded.

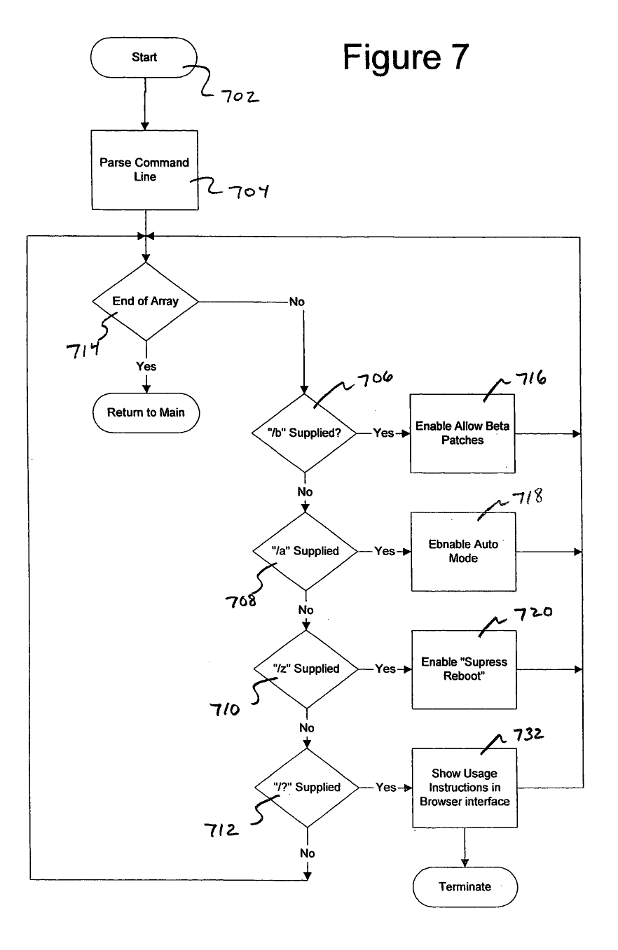

The processing 606 of parameters received in a command line instruction as implemented in conjunction with the process of FIG. 6 is shown in further detail in FIG. 7. Command line variables may be switches providing instructions to include or not include certain actions. As may be seen in FIG. 7, the command line arguments may be split 704 into a string array. Then each string may be compared 706, 708, 710, 712 to useful switches until the end of the string array is reached 714. For each string compared, an action may be enabled or disabled 716, 718, 720, 722.

For example, the string array may be compared to “/b”, and if this matches the command line instruction the beta mode may be enabled. Such a command line instruction may include (or exclude) non-released beta updates to be included.

Further, the string array may be compared to “/a”, “/z” or “/?” to determine a match. If a match exists the auto mode may be enabled, the reboot function may be suppressed, or the usage instructions may be displayed, respectively. Each command line instruction may work as a toggle, which alternates between one of two respective states, such as auto mode enabled/disabled, for example.

Returning to FIG. 6, the program may next include a check 608 to verify the presence of any needed components. For example, if .XML format data is to be used, the target computer may be required to have MSXML running. If required programs are not available, the update program may prompt a user to have the required software packages installed before the update program will continue to run.

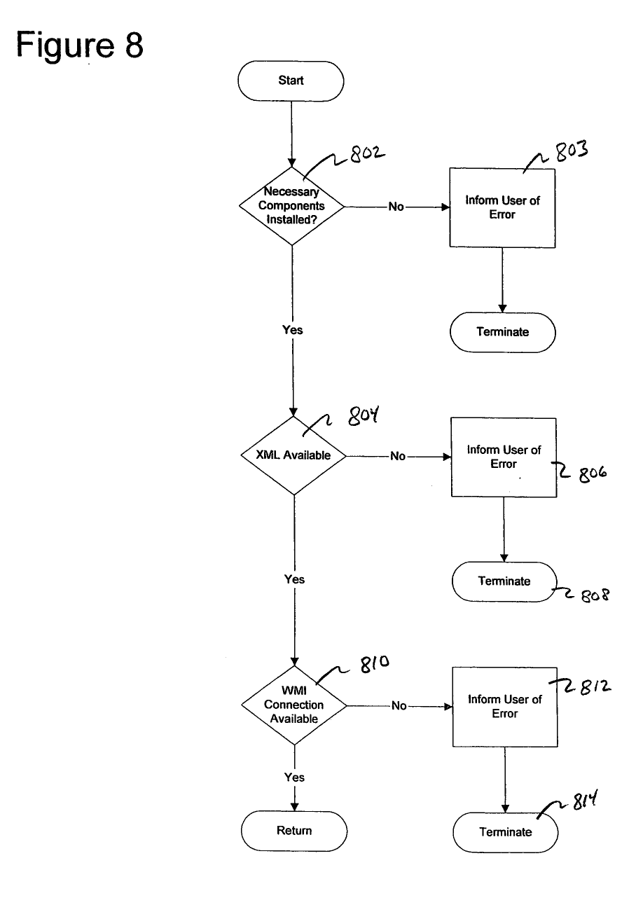

The step of checking 608 to verify the presence of any needed components is shown in greater detail in FIG. 8, which illustrates in more detail a process for checking a target computer to determine whether necessary software programs for running an update program are installed as implemented in conjunction with the process of FIG. 6. The target computer may be checked 802 for necessary software programs for running any update programs. If .XML format data is desired, the target computer may be checked 804 for MSXML. If the computer has MSXML the program may continue through the checking routine. If MSXML is absent the user may be informed 806 of this deficiency and the program may be terminated 808. Further, the system may be checked 810 for a WMI (“Windows Management Interface”) connection. WMI may be used to assist in the detection and identification of software packages on the target computer. If a WMI connection is found the program may continue through its checking routine. In the absence of the WMI connection the program may inform 812 the user of the error and may terminate 814.

Returning to FIG. 6, once the command line processing has been completed, the update program may download 610 a desired build list to allow comparison between the versions of the actual installations to be accomplished on the target computer, rather than on an administrative computer. The desired build list may also be embodied in a library of patches or updates, such that the desired build version for any software package is the most recent update or patch contained in the library. The desired version for any software package would thus be the most recent version contained in the library.

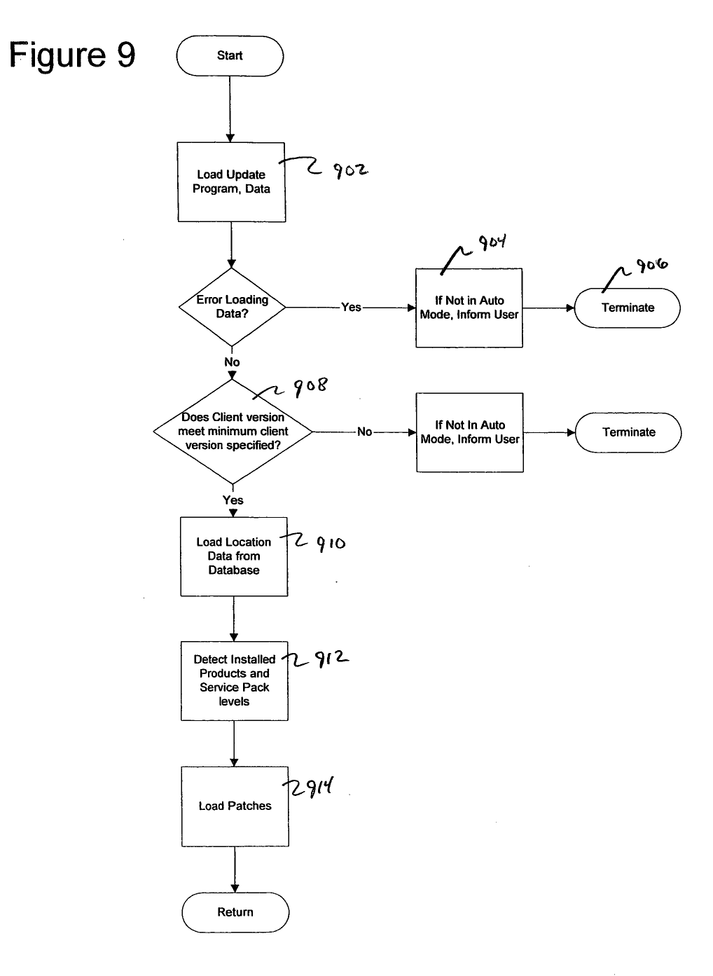

FIG. 9 illustrates in more detail the process for downloading 610 desired version information as implemented in conjunction with the process of FIG. 6. The update program itself may be loaded 902, such as from a Web server, for example. The update program may test itself, to determine if it is the most recent version by comparing to the desired build list. If the update program fails to identify itself as the proper version, the system may terminate 906 after informing the user 904. If the update program determines 908 that it meets at least the desired build, the update program may continue by loading 910 location data for the currency identification portion of the program, and testing 912 the installed software. Testing the installed software may include determining capability and at least the session information. This version information may then be compared with the desired build list to determine if updates are necessary. If updates are necessary the update program may load 914 the necessary installation software for each update required to bring the system to at least the desired build level.

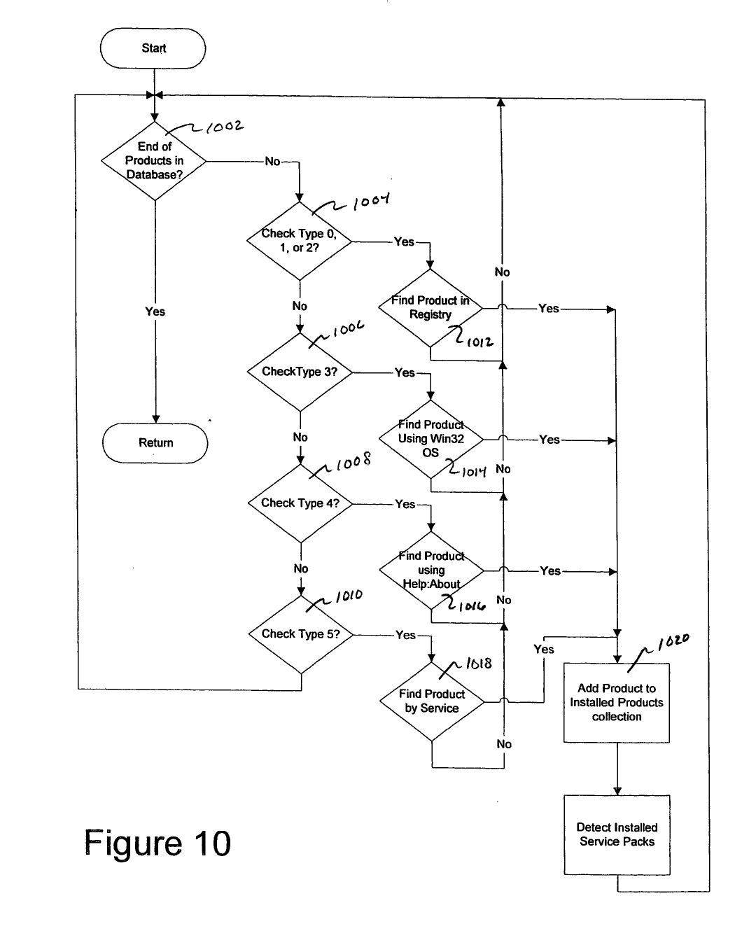

The process of detecting installed products is shown in greater detail in FIG. 10. As shown in FIG. 10, a products database may be looped through, testing for each successive product, until no remaining products are detected 1002 in the database. Each product in turn may be tested 1004, 1006, 1008, 1010 based on the type of checking requested and stored in the “check type”. This check type holds the type of checking that is desired to be performed. For example, if check type is set to zero, one, or two, the software packages to be installed may be tested 1012 using registry information. If check type is set to 3, the software packages to be installed may be tested 1014 using the Win32_OperatingSystem class in the WMI database. If check type is set to 4, the software packages to be installed may be tested 1016 using the Win32_Product class in the WMI database, and if check type is set to 5, packages to be installed may be tested 1018 by looking for the presence of a specific Windows service. Once the software product is determined, utilizing one of the methods described above, or any alternative known method, the software product may be added 1020 to and identified in the installed product list for comparison to the desired build level.

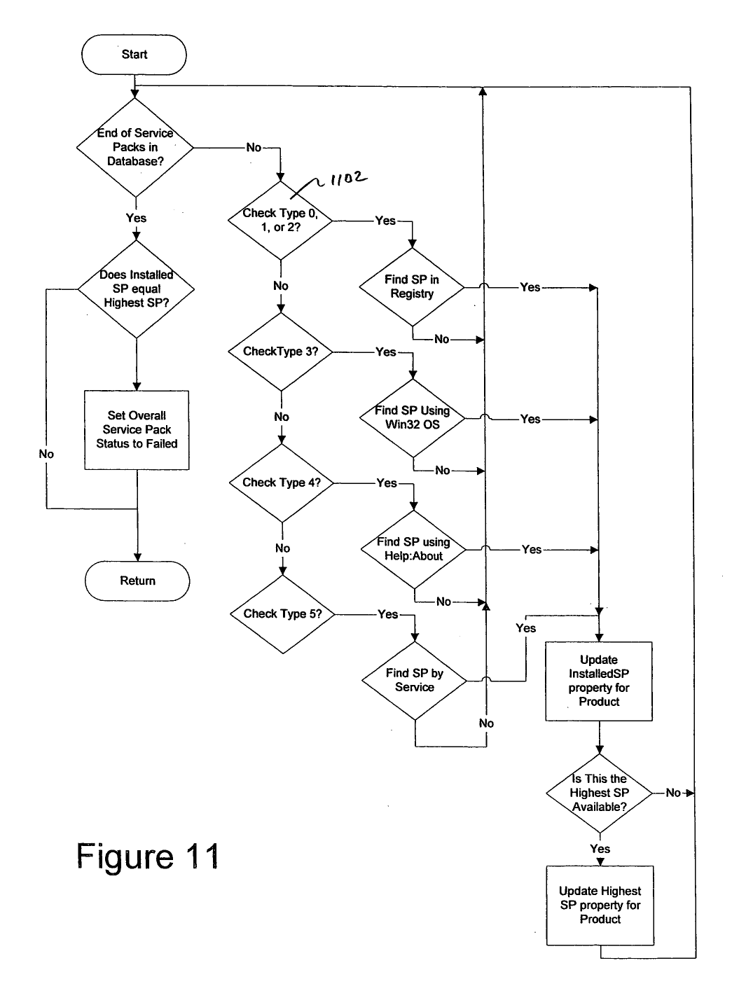

The same process may then be repeated for service packs detected in the database, as shown in FIG. 11. This identification process progresses similar to the identification of the installed software packages as described with respect to FIG. 10. In that regard, the check type disclosed herein above may be used. Briefly, the check type setting determines the testing that may occur. For example, for check types 0, 1, or 2, the registry may be used to determine the available updates. Similarly for check type 3, 4, or 5, the available updates may be determined by the Win32_OperatingSystem class, the Win32_Product class, or by the presence of a specific Windows service, respectively.

This determination may be made accounting for various update issues such as necessary updates, and superceded updates, for example. A necessary update may be an update in a series of update which necessarily needs to be included within an update chain in order for the future update be successful. Superceded updates on the other hand may include updates which are rendered superfluous by a later released update. If a necessary update is encountered both the necessary update and the final update may be included in the update list for installation, while a superceded update need not necessarily be included in such a list.

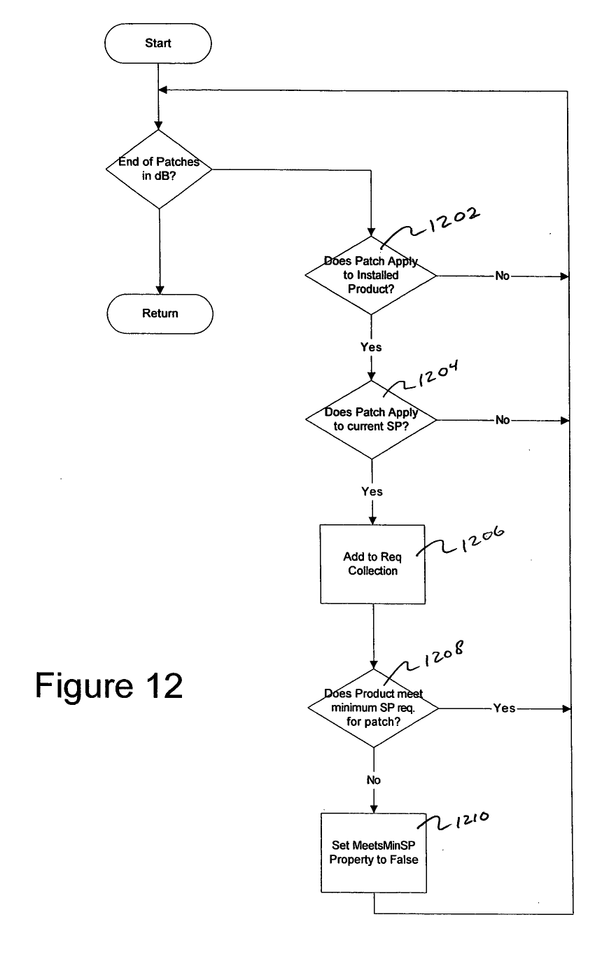

The update program may iterate 612 through the required updates collection, to load patches or updates to be included in the desired build configuration. This process is shown in greater detail in FIG. 12. An update or patch may be tested 1202 to determine whether the patch applies to an installed product. If the patch or update does not get added to the collection of required patches or updates. Next, the patch or update may be tested 1204 to determine if the patch or upgrade applies to the current service pack level of the installed software. If it is determined that the patch or update does not apply to the current service pack, the patch or update does not get added to the collection of required patches or updates. Thus, if the patch or update applies to both an installed product and to the current service pack for that installed product, the patch or update gets added 1206 to the collection of required patches. The patch or update can also be tested to determine 1208 whether the patch or update meets a minimum service pack requirement, and if not, a flag may be set 1210 indicating that the patch does not meet the minimum service pack requirement. Once all patches or updates available in the library have been either added to the required collection or excluded, the required collection represents the desired build list.

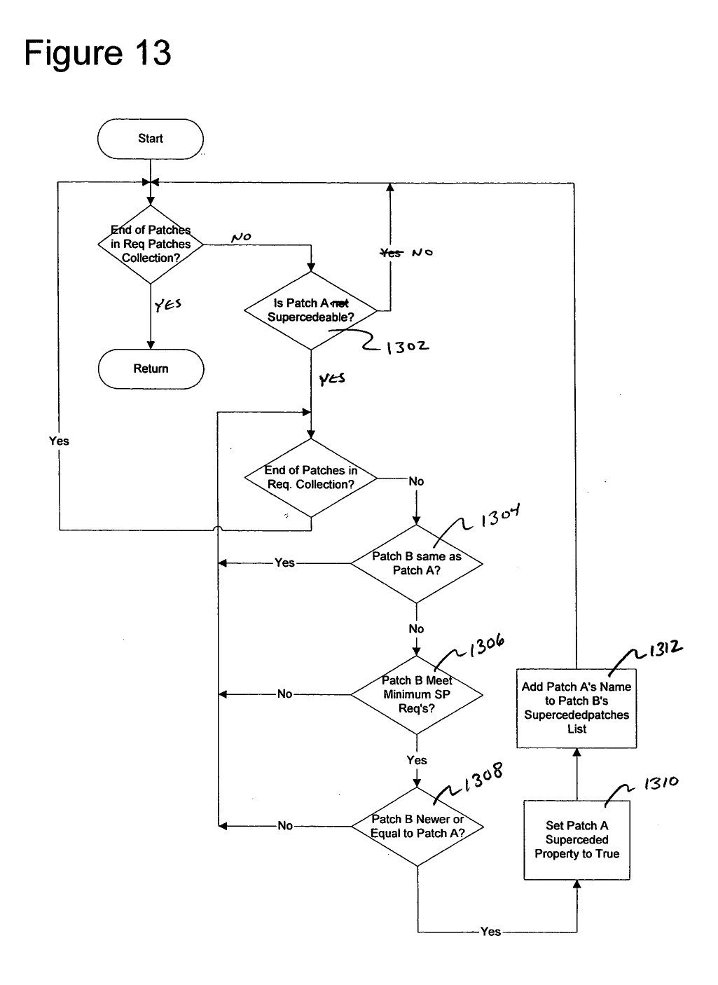

FIG. 13 shows a method for determining whether updates or upgrades have been superceded, i.e., are required to be installed in order to provide proper function to the associated software package, or whether later patches or updates obviate (“supercede”) the necessity of installing the software patch or update. Updates may directly be determined to be considered superceded by another update if the second update contains an equal or higher version of every file in the previous update (“Patch A”), and the second update (“Patch B”) meets minimum version levels for the software package being updated. A property value for Patch A may be set to “superceded”, and superceded updates may be removed from the required updates collection, such that they will not be verified or installed. As shown, updates may be designated as “NotSupercedable” in version record, in which case the update program will not parse a particular update to determine if it is required, such that the particular update will always be verified and installed if not already installed. If it is determined 1302 that a patch is supercedeable, the patch may be tested 1304 to determine whether the patch is the same as the next patch for the software package. If it is determined 1304 that that Patch B is not the same as Patch A, Patch B may be tested to determine 1306 whether Patch B meets minimum service pack requirements. Finally, Patch B may be tested to determine 1308 whether Patch B is newer than or the same age as Patch A. If Patch B passes each test, Patch A may be considered to be superceded, and a superceded flag may be set 1310 in association with Patch A. Patch A's name may also be added 1312 to a list of patches superceded by Patch B. If Patch B fails any of the tests, i.e., is determined to be the same as Patch A, is determined not to meet minimum service pack requirements, or is determined not to be newer or equal to patch A, Patch A will not be marked as superceded. Thus, patches marked as superceded will be excluded from the installation list without resort to an external table identifying whether patches have been superceded.

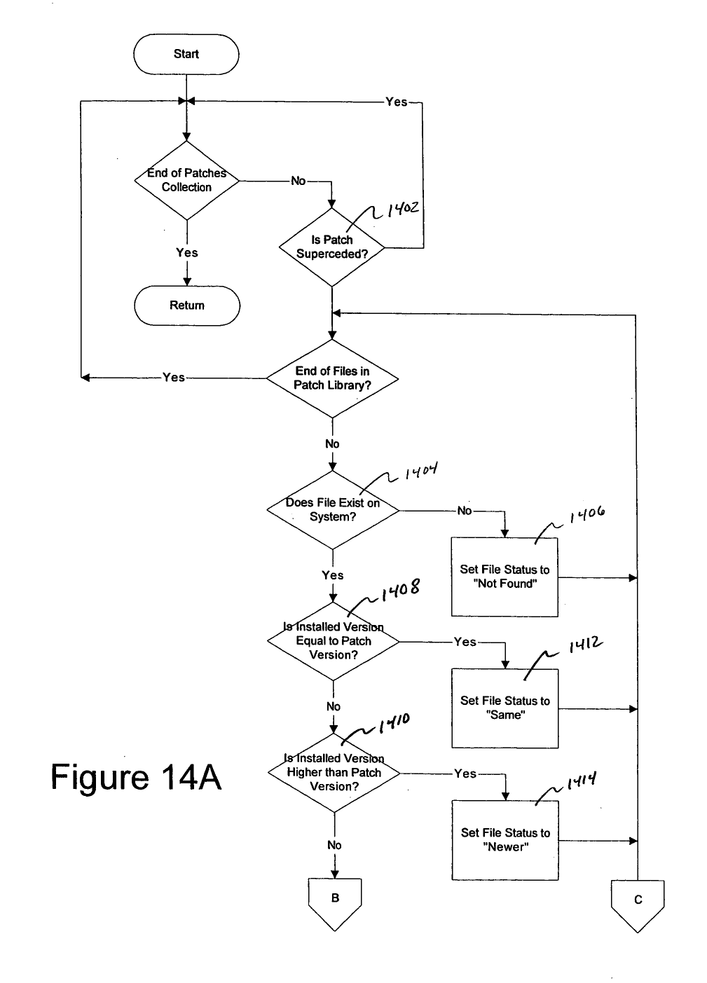

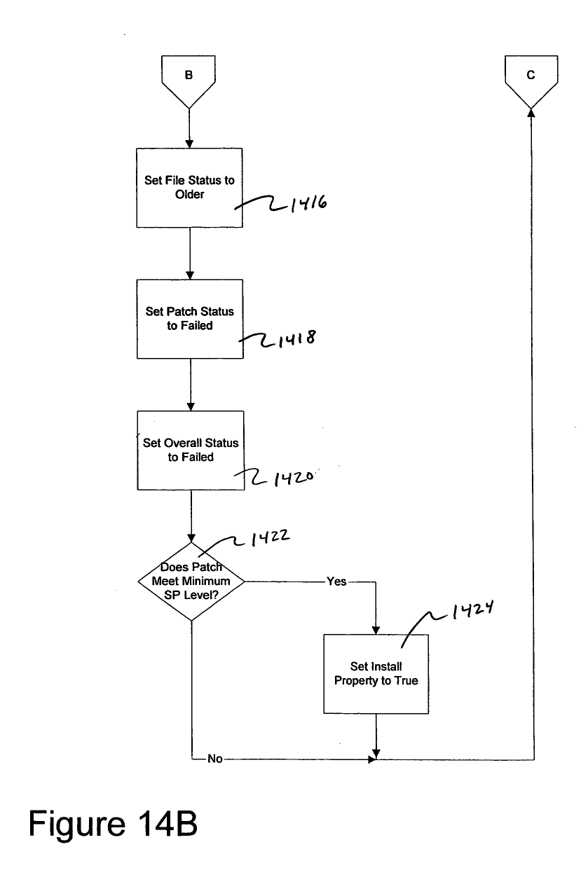

As shown in FIG. 6, the process may next verify 616 the updates. As shown in more detail in FIG. 14, the process of verifying patches or updates which have been added to the required collection of patches or upgrades may comprise testing the patches in the collection of required patches and updates to determine whether the patches or updates are valid. Additional tests may be implemented to ensure the availability of the update or patch for installation, with flags set such that a report may be generated identifying whether the patch or update is available to be installed, is the same as the presently installed software package, or is an older version than the presently installed version. As shown in FIG. 14, for each of the patches in the update library, the patch may first be tested 1402 to determine if it has been superceded. If the patch has been superceded, the patch may be excluded from the build list. Next, it may be determined whether the target of the patch is present on the target computer. If it is determined 1404 that the software package associated with the patch is not on the target computer, the patch may be marked 1406 as “not found” for inclusion in a later report, and excluded. Next, it may be determined 1408, 1410 if the patch or update is the same as or older than the software on the target computer. If it is determined 1408 that the patch is an older or the same version, the patch may be so marked 1412, 1414 and excluded. If the patch is neither older nor the same as the installed software, a file status flag may be set 1416 to “older”, to indicate that the installed software package is older than the patch, and a patch status flag set 1418 to “failed,” indicating that the installed software does not comply with the desired build. If any software update or patch is marked “older,” an overall system flag may be set 1420 to “failed,” indicating that the target computer is not current. Finally, if it is determined 1422 the update or patch meets the minimum service pack level requirement, an install flag may be set 1424 to true, indicating that the update or patch is required to be installed to bring the target computer to a current condition. Accordingly, the build list may be refined to be embodied in a list of all available patches, with patches or updates required to be installed indicated by a failed patch status and a true install property.

Comparison of individual files may be calculated using both a file name and a checksum for the file. The checksum may be calculated using an API provided by the Windows operating system, specifically “MapFileAndChecksum( ).” If an update contains a file with a version that is equal to the installed file, the checksum data may be compared. If the file versions and checksums match, the file may be reported as “Same” to a user. If the file versions match but the checksums do not, the file may be reported as “Newer” if the same file exists in a more recent update, or reported as a “Checksum Error” if there is no other update that is more recent and contains the file.

As shown in FIG. 6, if an automatic mode is implemented, the update program may automatically install 616 all patches marked as required to be installed, and reboot if required. If an automatic mode is disabled, the update program may present 618 a user with a status report, detailing which updates are required based on installed software packages, and the results of the verification of each update. If any updates are marked as required to be installed, the update program may present a user with an update selection function to allow a user to choose all, some, or none of the updates to install. After the user clicks an “Install” button, any selected updates may be installed.

Updates may be marked as requiring the target computer to be rebooted prior to a next update being installed. Such information may be included in a version record, such as shown in FIG. 4. If any updates are designated as requiring rebooting, a user may be instructed to reboot the system before the next update is installed. The update program may store status information to allow the update program to restart at the same point at which the reboot was initiated. After the last update has been installed, the user may be instructed to reboot the system manually and to re-run the update program to verify that all updates have been installed correctly.

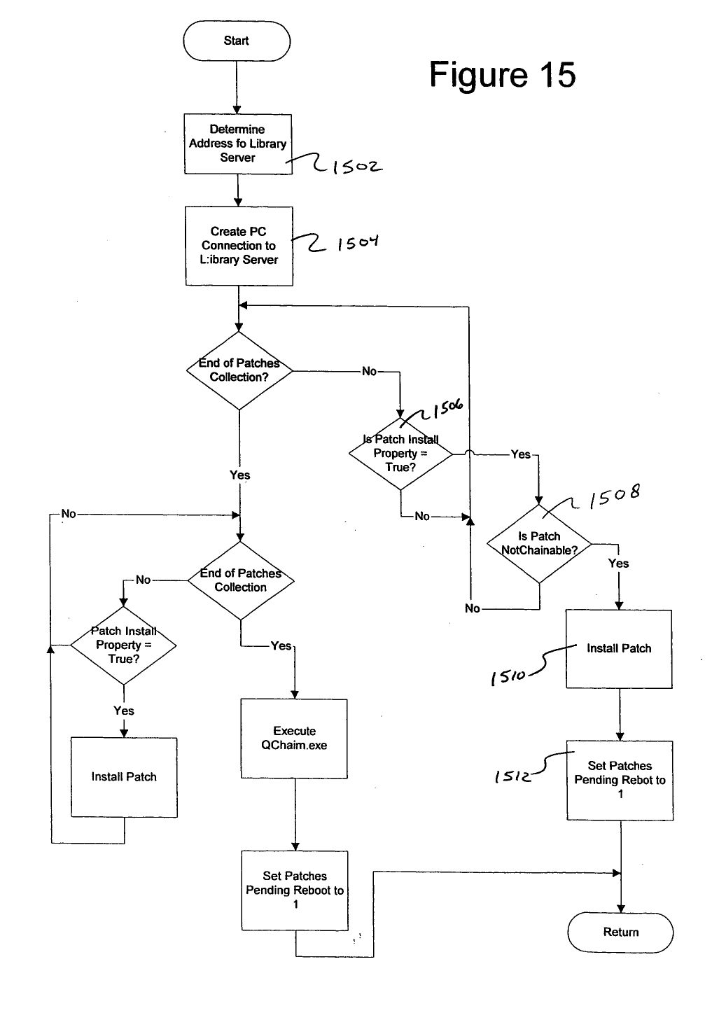

FIG. 15 illustrates in more detail a process for installing updates as implemented in conjunction with the process of FIG. 6. Once a set of patches, such as one patch or more, is determined to reach a minimum desired build level, the installation of the patches may proceed according to the process depicted in FIG. 15. This process may include determining 1502 the file server on which the patch or update is available from the local registry, and creating 1504 a connection with this file server. The process may then progress through each patch until the patches determined 1506 to be required to be installed have been installed 1510. Additionally, a flag may be tested 1508 for each update or patch to indicate whether the patch or update is chainable.

Update or patch installations may require that the computer on which the installation occurs rebooted upon completion of the installation. Chaining is a term that refers to installing more than one software patch or update before rebooting. Chaining may occur without adverse effect to follow on installations, but in certain circumstances, a patch or update may require that the server be rebooted before installing any further patches or updates. An “unchainable” flag may be implemented to identify when a reboot must occur before the next installation of a patch or update. If the patch or update is unchainable, installation of the next succeeding patch or update may be skipped., and a flag may be set 1512 to execute the update program anew after re-boot, thus causing the next successive patch or patches to be installed after the reboot. Accordingly, the program will install all patches or updates for which unchainable flags are not set, reboot, then again run all patches or updates still requiring execution for which unchainable flags are not set, until all patches or updates have executed.

Upon completion of the installations the computer may be rebooted, depending on a user defined switch that may be set to prevent this from occurring. If the user has set a no reboot switch the installation process may cease.

The present invention may be embodied in other specific forms than the embodiments described above without departing from the spirit or essential attributes of the invention. Accordingly, reference should be made to the appended claims, rather than the foregoing specification, as indicating the scope of the invention.

What is claimed is:

1. A method for applying software upgrades to a networked computer, comprising the steps of:
running an executable program on a target network computer to determine the configuration of at least one installed software package on the target computer;
comparing the determined configuration to a list of current configurations for installed software; and
determining whether the current configuration of the at least one installed software package is the current configuration for the installed software package, and
when said determination determines that the configuration of the at least one installed software package is not the most current configuration, causing the target server to obtain and run any necessary software upgrades necessary to bring the configuration of the at least one installed software package to current configuration.

2. A process for upgrading software resident on a networked computer, said process comprising the steps of:
executing a computer program on a networked computer to determine operating versions of at least an installed software component;
comparing the determined operating versions to a current software version list;
identifying software components with operating versions discrepant from the current software version list; and
upgrading discrepant software on the networked computer.

3. The process of claim 2, further comprising generating a list of discrepant software.

4. The process of claim 2, further comprising determining the required update for discrepant software.

5. The process of claim 2, wherein the networked computer resides on an internal network.

6. The process of claim 2, wherein the networked computer resides on an open network.

7. The process of claim 6, wherein the open network is the internet.

8. The process of claim 2, wherein the networked computer is a server.

9. The process of claim 2, wherein the networked computer is a workstation.

10. The process of claim 2, further comprising controlling the update operations from an administrative server, wherein the administration server is communicatively coupled to the network suitable for transferring files to the networked computer.

11. The process of claim 10, wherein the file transfer occurs through one of at least remote control of hardware or software.

12. The process of claim 2, wherein the software upgrades are stored on one of at least a library server and administrative server.

13. The process of claim 2, wherein said executing a computer program includes executing commands suitable to cause the networked computer to access a remote storage site, and download and install a software program capable of determining the identity and configuration of software installed on the networked computer.

14. The process of claim 2, further comprising compiling the determined operating versions into a list.

15. The process of claim 14, further comprising reporting the list to an administrative computer.

16. The process of claim 15, further comprising formatting the list in a format suitable to be read by software operating on an administrative computer.

17. The process of claim 15, wherein said reporting includes a tagged field format.

18. The process of claim 17, wherein the tagged field format is HTML.

19. The process of claim 17, wherein the tagged field format is XML.

20. The process of claim 2, wherein the current software version list is based on software installed on the networked computer.

21. The process of claim 20, wherein the current software version list is substantially developed by parsing the operating versions of the software installed on the networked computer and the current software version list.

22. The process of claim 2, wherein the current software version list is based on an externally generated list.

23. The process of claim 22, wherein the externally generated list is generated by a system administrator.

24. The process of claim 22, wherein the version list includes at least one older version of a software package, said older version suitable for maintaining compatibility with a proprietary software package

25. The process of claim 2, wherein said identifying includes generating an update list of software to be upgraded to reach the current software version list.

26. The process of claim 25, wherein the update list identifies the current software version list and the determined operating versions.

27. The process of claim 25, wherein the update list is limited to discrepant software.

28. The process of claim 25, wherein the update list includes at least one intermediate version suitable for reaching the current software version.

29. The process of claim 28, wherein the update list is sequenced to identify that the intermediate version be installed before the current software version.

30. The process of claim 25, wherein the update list is communicatively coupled to a program for generating an update script.

31. The process of claim 30, wherein the update script is installed on the networked computer suitable to cause the networked computer to download and install updates to installed software component consistent with the current software version list.

32. The process of claim 30, wherein the update script is substantially generated by aggregating script modules associated with at least one required update.

33. The process of claim 25, wherein the networked computer generates an installation report identifying the status of at least one installation.

34. The process of claim 33, wherein the installation report is forwarded to an administrator.

35. The process of claim 33, wherein the installation report is stored for later use in determining whether additional updates are required for the networked computer.

36. The process of claim 2, wherein at least one of said executing, said comparing, said identifying and said upgrading occurs automatically.

37. The process of claim 2, wherein said executing includes starting the computer program on the networked computer.

38. The process of claim 37, wherein said starting includes providing the command line to run the program at the command prompt.

39. The process of claim 38, wherein the argument entered at the command line may be split into a string array.

40. The process of claim 39, wherein the argument is suitable for being compared to switches.

41. The process of claim 38, wherein the command line resides on the networked computer.

42. The process of claim 2, wherein said executing includes initializing the global variables on the networked computer.

43. The process of claim 2, wherein said executing includes setting at least one switch indicative of the inclusion of beta updates.

44. The process of claim 2, wherein said executing includes verifying the presence of components.

45. The process of claim 44, wherein the components include .XML format data

46. The process of claim 44, wherein the components include MSXML.

47. The process of claim 2, wherein the current software version list is downloaded to the networked computer.

48. The process of claim 47, wherein the downloaded version is compared to determine if the version is the most recent version.

49. The process of claim 2, wherein said upgrading includes loading the installation software for all updates that apply to the installed software packages into a required updates collection data structure.

50. The process of claim 2, wherein said upgrading includes removing superceded updates.

51. The process of claim 2, wherein said upgrading substantially occurs automatically.

52. The process of claim 2, wherein said upgrading occurs through a user interface.

53. The process of claim 2, wherein said updating includes rebooting the networked computer.

54. The process of claim 2, further comprising verifying said upgraded discrepant software.

55. The process of claim 2, wherein the determination of operating versions is performed substantially using the registry.

56. The process of claim 2, wherein the determination of operating versions is performed substantially using the win 32 operating system

57. The process of claim 2, wherein the determination of operating versions is performed substantially using the win 32 product

58. The process of claim 2, wherein the determination of operating versions is performed substantially using service.

59. The process of claim 2, wherein said upgrading includes determining if an upgrade is necessary.

60. The process of claim 59, wherein a necessary upgrade is included in the update list.

61. The process of claim 2, wherein said upgrading includes determining if an upgrade is superceded.

62. The process of claim 61, wherein a superceded upgrade is excluded from the update list.

63. A method for maintaining a desired software configuration on a network accessible computer at at least a compliance level, said method comprising:
testing the software on the network accessible computer to identify the build level of the network accessible computer;
comparing the identified build level to the compliance level;
generating a list of non-complying software resulting from said comparison;
determining updates needed to bring software into compliance; and
installing said determined updates to thereby bring the software into compliance.

64. A computer system incorporating resident software for upgrading at least one computer resident in the system, said computer system comprising:
software on the resident computer to identify the build level of the resident computer, said software comprising:
code for comparing the identified build level to the compliance level;
code for generating a list of non-complying software resulting from said comparison;
code for determining updates needed to bring software into compliance; and
code for installing said determined updates to thereby bring the software into compliance.
